(19) United States
(12) Patent Application Publication
(10) Pub. No.: US 2007/0121905 A1
(43) Pub. Date: May 31, 2007

(54) Method and device for carrying out telephone campaigns

(76) Inventors: Thorsten Muhling, Karlsruhe (DE); Joachim Hubele, Dossenheim (DE); Jochen Weiss, Walzbachtal (DE)

Correspondence Address: WILLIAM COLLARD;COLLARD & ROE, P.C., 1077 NORTHERN BOULEVARD, ROSLYN, NY, 11576, US

(21) Appl. No.: 11/499,325

(22) Filed: Aug. 4, 2006

(30) Foreign Application Priority Data
Aug. 5, 2005 (DE) 10 2005 036 905.7

(51) Int. Cl. H04M 3/00; H04M 5/00

(52) U.S. Cl. 379/266.07

(57) ABSTRACT

A method and device for carrying out telephone campaigns is provided. Usually, unsuccessful calls to customers represent the largest cost factor in telephone campaigns that call centers must overcome. Aside from the costs for an unsuccessfully occupied dialer, costs for connection fees also become noticeable, for example in the case of connections that are cut off again immediately, or connections with answering machines. The method and the device provided herein improves the efficiency of telephone campaigns and saves resources in that the totality of customers is no longer cyclically run through as a whole, but is broken down into partial packets by a central control. These partial packets are then merely run through during an established running time, to carry out telephone campaigns, particularly advertising and sales campaigns.

### CROSS REFERENCE TO RELATED APPLICATIONS

Applicants claim priority under 35 U.S.C. §119 of German Application No. 10 2005 036 905.7 filed Aug. 5, 2005.

### BACKGROUND OF THE INVENTION

1. Field of the Invention

The present invention relates to a method and a device for carrying out telephone campaigns using a central control, at least one dialer, at least one database, as well as an achievability or reachability filter. The database makes a totality of customers available at the beginning of a telephone campaign, and this totality of customers is run through by the dialer. The dialer undertakes the attempt of establishing a connection with essentially all of the customers contained in the totality, at least once, preferably by telephone, this attempt is evaluated by the reachability filter, and connections that have been established successfully are passed on to agents.

2. The Prior Art

A method of this type is previously known from U.S. Pat. No. 5,815,566 A. In this known method, customers are automatically contacted by telephone from a call center, using a “predictive dialer,” and connections established with customers are switched over to free agents, in other words employees of the call center, who conduct telephone sales conversations with the customers. A dialer is an automatic dialing device that dials a list of telephone numbers, one after the other. The function of the “predictive dialer” is characterized in that the dialer already attempts to establish a connection before an agent is actually available to take it over. On the basis of empirical collected data concerning the length of conversations and the ability to reach customers in the case of such calls, parameterization of the dialer can be achieved, with which an agent is available to take over the call in timely manner for almost every call that is connected.

In this connection, it can be determined from various parameters whether or not the customer can be reached. Reachability does not exist, for example, if no ring tone occurs or if an answering machine answers the call. Likewise, a connection that is terminated after only a very short period of time is also considered unsuccessful.

The U.S. patent cited above furthermore teaches a solution for the problem that in the case of a call coming into the call center, the agent had to log out of the system. The requirement that the agent had to log out meant that after his or her conversation, the agent became unavailable for a certain time, because of having to report or log back onto the system first. The U.S. patent eliminates this problem by separating the agents into those for incoming (inbound) calls and those for outgoing (outbound) calls.

A further U.S. reference, U.S. Patent Application Publication No. 2002/0067820 A1, describes a management method according to which the address lists containing the customer data used by the agents, in particular, are processed in a particular way. First, the employees are informed about previous conversations with the customers in question, and any business transactions that might already have been concluded with them. Second, the address lists of several campaigns are coordinated with one another, with the goal of avoiding multiple calls to a single customer within a short period of time.

These deliberations are supposed to help use the agents' time as efficiently as possible. In this connection, the efficiency results primarily from the successful conclusion of purchase contracts with customers, so that it is absolutely necessary not to scare them off. But customers can be scared off if the customer is called several times within a short period of time, or if telephone contacting is continued even after a transaction has already been concluded, for example. The telephone costs are also important for the efficiency of the work of a call center, so that unnecessary calls should be avoided, if possible.

Usually, an advertising or sales campaign is organized in such a manner that an address pool of customers is made available for it, which exists, for example, in the form of a list of telephone numbers. The dialer runs through this list, whereby customers who have been reached are removed from the list or marked in it, so that they are not called again. After a run-through (pass), the reduced list is run through again, from the beginning, so that a cyclical procedure results, within the constantly decreasing list.

As a result, however, a customer who basically cannot be reached may be called unsuccessfully as much as 60 times, within a campaign, because of the cyclical nature of the method of procedure, depending on the number of list run-throughs. Because contact with this customer becomes less likely with each unsuccessful call, the efficiency of the call center decreases significantly.

### SUMMARY OF THE INVENTION

In view of this background, it is an object of the invention to provide a method and a device that increase the efficiency of call centers, particularly their contract conclusion quota, and save the available resources, namely dialer time and time of the agents.

These and other objects are achieved, according to one aspect of the invention by a method for carrying out telephone campaigns using a central control, at least one dialer, at least one database, and a reachability filter. In accordance with the method, the database makes a totality of customers available at the beginning of a telephone campaign, and this totality of customers is run through by the dialer. In so doing, the dialer attempts to establish a connection with essentially all of the customers contained in the totality, at least once, preferably by telephone. This attempt is evaluated by the reachability filter, and connections that have been established successfully are passed on to agents. In accordance with the method, wherein the central control selects a partial amount from the totality of customers and assigns a running time to it, whereby the central control removes customers that have been called successfully from the partial amount, and only continues to cyclically run through the remaining partial amount until the end of the running time.

In another aspect, the invention provides a device for carrying out telephone campaigns, including a central control, at least one dialer, at least one database, as well as a reachability filter, whereby a totality of customers can be made available at the beginning of a telephone campaign, using the database, and this totality of customers can be run through by the dialer, whereby an attempt to establish a connection with essentially all of the customers contained in the totality can be made using the dialer, at least once, preferably by telephone. This attempt can be evaluated by the reachability filter, and connections that have been established successfully can be passed on to agents. A partial amount from the totality of customers can be selected by the central control, and a running time can be assigned to it. Customers that have been called successfully can be removed from the partial amount, using the central control, and only the remaining partial amount can continue to be run through, until the end of the running time. Practical embodiments can be derived from the embodiments discussed below.

According to the invention, a totality of customers who are supposed to be called within the framework of the current campaign is made available by a database. A central control organizes the totality of customers into partial packets, to which a running time is assigned. A dialer now attempts, in known manner, to establish a connection with the customers. As previously known, it can happen in this connection that individual customers cannot be reached, for example because they are away on vacation. In the past, these customers would be called again and again numerous times after the list has been run through.

According to the invention, because the dialer cyclically runs through not the entire amount of customers, but rather merely a partial amount during the running time, an individual customer is called less frequently. As a result, it is possible that customers who could still be reached in a later attempt are lost, but customers who cannot be reached are not contacted unnecessarily.

The method of procedure of division into individual partial packets additionally has the significant advantage that the dialer is necessarily emptied. The dialer, which is actually a conventional one, evaluates the results in this manner from the start, after each running time has elapsed, instead of doing so only at the end of the campaign. In this way, better results in terms of telephone contact can additionally be achieved by assigning to the customers agents who are as ideally suited to them according to various criteria as possible as a function of the interim results.

In an advantageous embodiment, the central control rejects the current partial packet of customers after the running time has elapsed, and selects a different partial packet. Once the running time has elapsed, it can be assumed that significant success can no longer be expected from investment of further time and effort. The “easy successes” have therefore been posted for the call center, and the same contract conclusion quota can be achieved at significantly lower costs, by means of using a totality of customers that is greater overall.

In this connection, it is certainly practical if customers who were contacted once during a campaign are not contained in another partial packet. If the customers were already contained in a partial packet that was not completely processed during the running time, however, these customers can occur again in a later partial packet.

In this connection, it is not practical to allow the cyclical run-through of the partial amounts to start from the beginning again after the totality of customers has been run through once. The efficiency is greatest during the first run-throughs, and could only be reduced, on the average, in this manner.

For qualification of a customer as reachable or unreachable, it is practical to use a reachability filter that checks the calls that are made. In this connection, it is advantageous to consider those connections to be unsuccessful that were made with answering machines, which are hung up immediately, and attempts in which no ring tone occurs, right from the start.

It is sometimes helpful for the work of the agents if a set of data that applies to an individual customer is available to the agents for every customer, by means of the central control. This data set can particularly include information such as the name and address of the customer. The data set can also include information about previous contract conclusions with the customer or other known properties that were entered into the system during earlier conversations. In this regard, it is furthermore practical if the agent can supplement this information, preferably already during the conversation.

From this information, the requirement also results that a customer is removed from the totality of customers who are called within the framework of a campaign, after a successful contract conclusion. Alternatively, he/she can also be marked as a successful contract conclusion, and this indication can be advantageous for subsequent automatic statistics.

Finally, a “predictive dialer” should be used for establishing the telephone connection between agent and customer. This feature brings the advantage of the greatest possible capacity utilization of the individual agents, in that a new connection is established even before a line becomes free, so that no waiting times occur on the part of the agents.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings:

FIG. 1 shows a totality of customers in a schematic representation, according to a conventional method,

FIG. 2 shows a totality of customers in a schematic representation, according to the method according to the invention,

FIG. 3 is a sequence diagram of the calling method according to the invention, and

FIG. 4 is a sequence diagram of the selection method according to the invention.

### DETAILED DESCRIPTION OF PREFERRED EMBODIMENTS

Referring now in detail to the drawings, FIG. 1 shows a totality of customers 1 according to a conventional method. Usually, this totality 1 is considered as a whole unit. A central control in the system of a call center derives a customer data set from this totality 1, organized as a list, and attempts to establish a connection with this customer. If it succeeds, the customer is passed on to an agent and a sales conversation begins. If it does not succeed, the address is left in the list, unchanged. After the totality of customers 1 has been run through, it is started again with the addresses that have not yet been reached. Usually, a totality of approximately 100,000 customers is called in this manner, within the framework of a campaign. In this connection, the list is run through approximately 40 to 60 times.

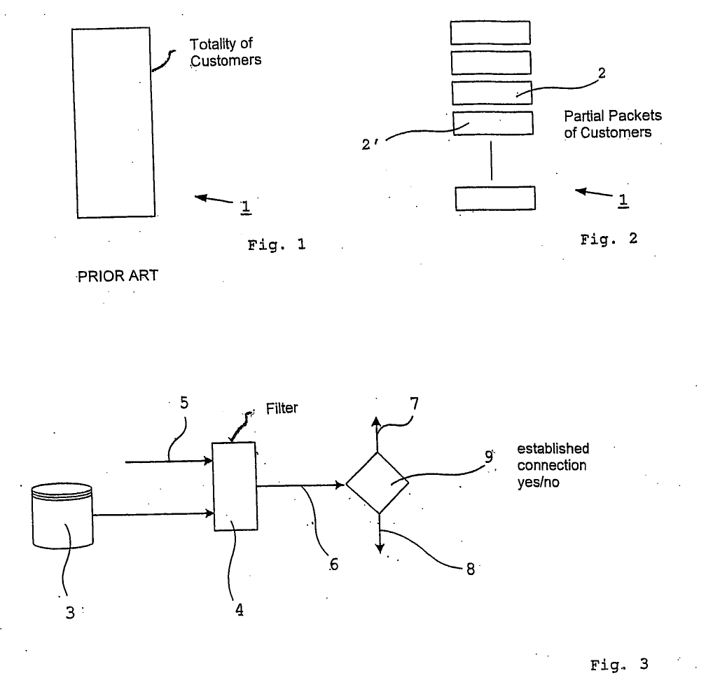

FIG. 2, on the other hand, represents the organization of a totality of customers 1 organized according to the invention. In contrast to the conventional method, this totality is divided into partial packets of customers 2, 2′, etc. by the central control, and each partial packet of customers is provided with a running time 5. Thus, the dialer is practically forced to empty itself regularly, and to make an evaluation of the partial packet 2, 2′ available, which can immediately flow back into the further work. Each partial packet 2, 2′ is cyclically run through during the running time 5. Because of the cyclical assignment of the partial packets 2, 2′ that now occurs, after the expiration of the running time 5, the efficiency of the campaign is significantly increased. This increased efficiently arises because a customer who already could not be reached several times will be reachable at a later time only with decreasing probability. Because of the early classification of a customer as “not reachable,” the calling time and, in some cases, also connection fees can be saved. If individual customers are not called during the running time 5, they can be contained again in a later partial packet 2, 2′.

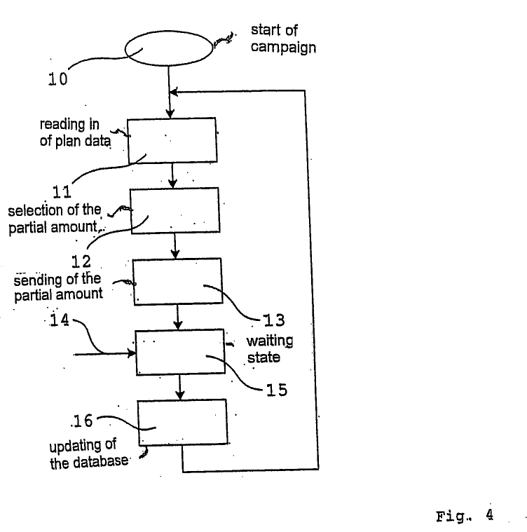

FIG. 3 shows the sequence of this method in detail. FIG. 3 shows a database 3, which makes a totality of customers 1, specifically a customer data set, available during the running time 5. A reachability filter 4 first checks whether or not a customer can be reached. In the case of fundamental reachability, for example because a connection is fundamentally possible, for example the line is busy or only the ring tone sounds, an attempt is made to establish a connection, fundamentally an inquiry 6 is made. In step 9 (establish connection yes/no) shown in FIG. 9, a determination is made as to whether a connection has or has not been established. Both in the case of a successful connection 8, and in the case of an unsuccessful connection 7, the customer data set is removed from the inventory, so that no further call is made to the customer in question.

FIG. 4 shows a method according to which the current partial packet of customers 2, in each instance, is made available to a dialer. For this purpose, a graphic interface in the form of a Web front end, with which he/she can start a campaign, is available to a campaign operator. In this connection, the totality of customers 1 is loaded into the database 3. The campaign operator can divide his/her campaign into partial packets 2 for different call centers by way of a user interface. In this connection, the sizes of the partial packets 2 and thereby the running time 5 are defined as plan data. The planning can be modified at any time, for future days, and can thereby be adapted to the resources of the call centers in question.

After the start 10 of the campaign, these plan data in step 11 are read in. On the basis of the plan data, data sets are selected in step 12, which together represent a partial packet of customers 2. The partial amount is sent in step 13. The transfer of these data between the campaign planning and the dialer takes place automatically, during the down times, in accordance with the plan that has previously been established. After the transfer, the process is in the waiting state 15, which state is left again only when the partial amount 14 is sent back to the system. Partial amount 14 is sent back to the system at the end of the running time 5, when the current partial amount 2 has been run through as planned. The return of the data sets triggers updating of the database in step 16. In this connection, the data sets can be evaluated once again, so that this evaluation is available as a basis for later campaigns.

The campaign ends at a point in time that can be configured, or when the totality of the data has been used up.

Although only a few embodiments of the present invention have been shown and described, it is to be understood that many changes and modifications may be made thereunto without departing from the spirit and scope of the invention as defined in the appended claims.

What is claimed is:

1. A method for carrying out a telephone campaign using a central control, at least one dialer, at least one database, and a reachability filter comprising the steps of:
(a) using the database to make a totality of customers available at a beginning of a telephone campaign;
(b) running through the totality of customers at least once in an attempt to establish a connection with substantially all customers in the totality of customers; and
(c) evaluating the attempt by the reachability filter and passing successfully-established connections on to a plurality of agents;
wherein the central control selects a partial amount of customers from the totality of customers and assigns a running time to the partial amount; and
wherein the central control removes customers that have been called successfully from the partial amount and continues to run cyclically through the customers that have not been called successfully remaining in the partial amount only until the running time ends.

2. The method according to claim 1, wherein the attempt to establish a connection with substantially all of the customers contained in the totality of customers is made by telephone.

3. The method according to claim 1, wherein the central control rejects the customers that have not been called successfully remaining in a first partial amount after expiration of the running time and selects a second partial amount.

4. The method according to claim 3, wherein the first and second partial amounts contain no elements that are contacted within the running times of the two partial amounts.

5. The method according to claim 1, wherein the totality of customers is run through only once.

6. The method according to claim 1, wherein the reachability filter classifies a customer as not reachable if no ring tone is received on the line, if an answering machine is recognized, of if the connection is cut off again before expiration of a minimum time.

7. The method according to claim 1, wherein an agent to whom a customer was passed on can change data in the database that are stored with regard to the customer.

8. The method according to claim 1, wherein after a successful sale to a customer by the agent, the customer is marked as a successful contract conclusion in the totality of customers or removed from the totality of customers.

9. A device for carrying out a telephone campaign comprising:
(a) a central control;
(b) at least one dialer;
(c) at least one database; and
(d) a reachability filter;
wherein a totality of customers can be made available at a beginning of a telephone campaign using the database and can be run through by the at least one dialer in an attempt to establish a connection with substantially all customers contained in the totality of customers at least once;
wherein the attempt can be evaluated by the reachability filter and connections that have been established successfully can be passed on to a plurality of agents;
wherein a partial amount from the totality of customers can be selected by the central control and a running time assigned to the partial amount; and
wherein customers that have been called successfully can be removed from the partial amount using the central control and the at least one dialer continues to run through only the customers remaining in the partial amount until the running time ends.

10. The device according to claim 9 wherein the attempt to establish a connection with substantially all customers contained in the totality of customers is made by telephone.

11. The device according to claim 9, wherein the at least one dialer is a predictive dialer.
